(19) United States
(12) Patent Application Publication
(10) Pub. No.: US 2025/0050537 A1
(43) Pub. Date: Feb. 13, 2025

(54) PRECAST CONCRETE PIPE COUPLING AND SYSTEM AND METHOD FOR MANUFACTURING THE SAME

(71) Applicant: AmeriTex Pipe & Products, LLC, Seguin, TX (US)

(72) Inventors: Kevin Thompson, New Braunfels, TX (US); Rocky Lorenz, New Braunfels, TX (US); Dylan Lorenz, Conroe, TX (US); Donald Ray Gokey, II, Livingston, TX (US); Christopher Lee Gokey, Livingston, TX (US)

(21) Appl. No.: 18/761,201

(22) Filed: Jul. 1, 2024

Related U.S. Application Data
(60) Provisional application No. 63/523,996, filed on Jun. 29, 2023.

(51) Int. Cl. B28B 21/76; B28B 7/28; B28B 13/02

(52) U.S. Cl. CPC B28B 21/76; B28B 7/28; B28B 13/02

(57) ABSTRACT

An apparatus and method for manufacturing precast concrete pipe couplings used in municipal and infrastructure systems includes a mold apparatus particularly configured for the formation of monolithic, unitarily formed concrete pipe couplings that facilitate the joining of intersecting and/or bending sections of straight concrete pipes. The mold apparatus comprises a base, adjustable mold walls, and primary and secondary mold cores that shape the internal flow channels of the couplings and that allow for the creation of complex geometries without the need for scoring, cutting, or rejoining pipe sections, resulting in couplings with smooth internal surfaces that enhance fluid flow and reduce maintenance requirements. A monolithic concrete pipe coupling formed by the foregoing method and apparatus exhibits flat external surfaces, facilitating easy stacking, storage, and installation.

### CROSS-REFERENCE TO RELATED APPLICATIONS

This application claims the benefit of U.S. Provisional Patent Application No. 63/523,996 titled “PRECAST CONCRETE PIPE FITTING,” filed by the inventors herein on Jun. 29, 2023, the specification of which is incorporated herein by reference in its entirety.

### FIELD OF THE INVENTION

The present invention relates generally to the field of construction materials and, more particularly, to an innovative system and method for creating couplings for concrete pipes used in municipal and other infrastructure systems and the couplings formed thereby. The invention particularly pertains to a novel method and apparatus for forming precast concrete pipe couplings that facilitate the joining of intersecting and/or bending sections of straight concrete pipes, in addition to the precast concrete pipe couplings formed by such method and apparatus. This invention addresses the need for more efficient, durable, and cost-effective solutions in the construction and maintenance of fluid conveyance systems, such as those used for stormwater, sewage, and other similar applications.

### BACKGROUND

Concrete pipes have long been used to direct and control the flow of liquids underground. The strength and reliability of concrete pipes have made them the standard for handling large amounts of water runoff, flood water, storm surges, and the like to divert those flows from areas where water might cause damage to property, carry sewage and other materials through a municipality to treatment centers, and the like.

Of course, every municipality has its own geography, such that the paths defined by a system of concrete pipes for purposes of controlling and directing such flows must vary from municipality to municipality, with many bends and intersections required for a fully functional system.

Historically, manufacturers of concrete pipe to be used for such purposes have commonly formed bends and pipe connections (commonly referred to as “fittings”) in accordance with a process by which, as shown in FIG. 1, two separate cylindrical concrete pipes 10 and 20 are joined together to form a connection. Cylindrical concrete pipes 10 and 20 intended for use in forming a concrete pipe fitting are typically formed using typical processes well known in the art, such as through centrifugal molding of concrete against an outer mold wall to form the cylindrical pipe. This process involves the use of a dry concrete mixture having a low water to cement ratio and a low slump typically of between 0-4 inches. Such a dry concrete mixture is necessary for use in centrifugal concrete pipe molding, as such pipes must be able to hold their shape immediately upon removal from the centrifugal molding machine.

In forming a traditional concrete pipe fitting, before the cast concrete pipes formed by the centrifugal molding process have fully cured, each of the pipes that are to be joined together to form the fitting are scored and concrete is removed at the scored section. As shown in FIG. 1, pipe 10 has been scored and then had a portion of concrete removed at opening 12, while pipe 20 has been scored and then cut at an angle 22 so that it may be brought into connection with pipe 10 to form a Y joint. In this previously applied method, reinforcing steel wire 14 that originally provided circumferential reinforcement to pipe 10 is cut and bent towards the incoming section of pipe 20 and tied or otherwise connected to similar wire reinforcement in pipe 20, and additional concrete is then manually applied around the joint to form a permanent connection between pipes 10 and 20 in the form of a Y-joint. Similar processes are likewise used to form curved pipe sections and other joints of varied configurations.

While the foregoing method has been a longstanding and standard practice, it carries a number of disadvantages. First, this manual process of forming a fitting often results in the finished fitting having interior imperfections in the formed flow channels, which can impede flow by providing surfaces on which leaves, trash, and other debris may become stuck when flowing through the fitting. This process is also quite labor intensive, requiring a team of individuals to undertake manual scoring of the molded, uncured pipes, manual reforming of the steel reinforcement, placement of the two pipe sections together at the intended orientation, and placement of additional dry concrete to the joint where the pipes are joined together to have them take and hold the shape of the intended fitting. Further, this method results in significant material waste resulting from the portions of concrete that are removed from the two separate pipes during the pipe-joining process.

Moreover, the finished fitting assembly, whether comprising a Y-fitting or a curved fitting, has a round exterior with curves or branches that prevent uniform stacking of finished fittings in a store yard of a manufacturing facility. This results in each stored fitting taking up a significant amount of ground space until it is placed on a truck for delivery to an installation site. Likewise, given the inability to store such fittings in stacked configurations, they are often sitting on the ground, making them prone to damage from ground-based store yard traffic, such as forklifts, flatbed trucks, and the like, as well as damage from simply placing them on the ground at angles that excessively stress the branch portion, causing it crack or break away from the primary pipe length of the fitting.

Still further, as such fittings are formed by bringing together separate cylindrical pipes that have been formed by the centrifugal molding process, the length of the finished fitting is often significantly longer than necessary to simply join two or more straight cylindrical pipe sections together, again adding unnecessary storage costs, material costs, and increased weight (and the associated increased difficulty in installation and costs of shipment). For example, in the case of a Y-type fitting as shown in FIG. 1, there must be sufficient length in the primary pipe length 10 to be able to support the weight of the pipe branch section 20 that is joined to primary pipe length 10 so that branch section 20 does not inadvertently separate during shipment, installation, and use in a municipal fluid handling system.

Even further, while linear pipe sections themselves have typically been formed through the above centrifugal molding process, such centrifugal molding process is unavailable for molding of pipe curves and intersections. Moreover, molding of pipe curves and intersecting segments through precast molding or the like has remained a challenge, particularly given the difficulty of having an inner core that could easily be stripped from a curving or intersecting section of heavy concrete pipe after it has been poured. Likewise, efforts to core out a formed concrete block to form such a fitting have been unsuccessful, as such processes require significant manual effort (and are not subject to methods implemented through computer aided design, or CAD, systems) to shape the conduit, resulting in a bored flow channel with significant imperfections and minimal uniformity

Thus, there remains a need in the art for devices for and methods of forming couplings for joining intersecting sections of straight, concrete pipe, particularly including bending and intersection couplings, that provide a consistently uniform and smooth flow channel, that reduce waste labor associated with their manufacture, that require less storage space and that reduce risk of damage during storage in comparison to previous concrete pipe fittings, but that nonetheless provide an efficient and reliable manner of implementing such couplings.

### SUMMARY OF THE INVENTION

Disclosed herein according to several exemplary embodiments are methods and apparatus for forming precast concrete pipe couplings that facilitate the joining of intersecting and/or bending sections of straight concrete pipes, in addition to the precast concrete pipe couplings formed by such methods and apparatus, that avoid one or more disadvantages of the prior art. A molding apparatus and method configured in accordance with aspects of the invention significantly improves upon traditional methods by reducing labor, minimizing material waste, and enhancing the durability and functionality of the pipe couplings.

In accordance with an embodiment of the invention, a mold apparatus is specifically designed for the efficient and precise formation of monolithic, unitarily-formed concrete pipe couplings. The mold apparatus comprises a base, moveable walls, and primary and secondary mold cores. These components are strategically configured to facilitate easy assembly and disassembly, which is crucial for efficient manufacturing processes.

The primary and secondary cores of the mold apparatus according to aspects of the invention form the internal flow channels of the pipe couplings, and are particularly configured to create complex geometries, such as Y-junctions or bends, without the need for cutting, scoring, or rejoining sections of pipe. This configuration allows for the formation of smooth internal surfaces that reduce flow resistance and minimize the risk of blockages.

A molding process configured in accordance with aspects of the invention involves placing the mold apparatus in a configuration that aligns with the desired shape of the pipe coupling. Concrete with a high slump range is then poured into the mold, ensuring it flows around the cores to form the coupling with precise internal and external geometries. This process not only ensures high-quality production but also allows for the use of concrete with higher slump values, which enhances the workability and finish of the product.

Once the concrete has been poured and allowed to cure, the mold apparatus can be opened such as by retracting the cores and moving the mold walls. This process is facilitated by the innovative design of the mold walls and cores, which in one embodiment are mounted on core sleds equipped with hydraulic systems for smooth, powered operation. This configuration ensures that the monolithic concrete pipe coupling can be removed from the mold without damage, maintaining the integrity of its complex internal structures.

The precast concrete pipe coupling produced in accordance with aspects of the invention is characterized by its monolithic, unitary construction. This construction eliminates joints or seams that could potentially weaken the coupling or impede fluid flow. The coupling is designed to connect seamlessly with standard sections of concrete pipe, providing a robust and reliable connection point within municipal and infrastructure piping systems.

Furthermore, the precast concrete pipe couplings produced in accordance with aspects of the invention comprise pipe couplings with flat external surfaces on the top and bottom. This feature significantly simplifies the storage and transportation of the couplings, as they can be easily stacked and handled. The flat surfaces also facilitate easier installation in the field, reducing the time and equipment needed to position and secure the couplings. Moreover, the pipe couplings have a smaller overall footprint than traditional pipe fittings used for joining pipe sections together, thus reducing the amount of material required for their manufacture and further easing storage, transport, and installation.

In summary, the present invention provides a transformative solution in the field of concrete pipe couplings. By integrating advanced mold design with an efficient molding process, the invention addresses longstanding challenges associated with the production of traditional concrete pipe fittings. The resulting precast concrete pipe couplings formed in accordance with aspects of the invention are not only more durable and functional, but are also more environmentally friendly and cost-effective compared to traditional configurations.

Still other aspects, features and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized. The present invention is illustrated by way of example, and not by way of limitation, in the figures of the accompanying drawings, in which like reference numerals refer to similar elements, and in which:

FIG. 1 is a representation of a prior art process for forming pipe fittings.

FIG. 2 is a top perspective view of a mold for forming a portion of precast concrete pipe coupling according to certain aspects of an embodiment of the invention.

FIG. 3 is a top perspective view of a portion of a precast concrete pipe coupling in the mold of FIG. 2.

FIG. 4 is a top perspective view of a portion of a precast concrete pipe coupling removed from the mold of FIG. 2.

FIG. 5 is a top perspective view of the portion of the precast concrete pipe coupling of FIG. 4 with the mold core removed.

FIG. 6 is a top perspective view of a second portion of a precast concrete pipe coupling formed for mating with the portion of the precast concrete pipe coupling of FIG. 5.

FIG. 7(a) is a perspective view of a precast concrete pipe coupling assembled from the portions of FIG. 5 and FIG. 6.

FIG. 7(b) is another perspective view of the assembled precast concrete pipe coupling of FIG. 7(a).

FIG. 8 is a side view through the assembled precast concrete pipe coupling of FIGS. 7(a) and 7(b).

FIG. 9 is a top perspective view of a mold for forming a portion of a precast concrete pipe coupling according to further aspects of an embodiment of the invention.

FIG. 10 is a side view of the mold of FIG. 9.

FIG. 11 is a bottom perspective view of a top portion of a precast concrete pipe coupling formed in the mold of FIGS. 9 and 10.

FIG. 12 is a top view of the top portion of a precast concrete pipe coupling of FIG. 11.

FIG. 13 is a top view of a bottom portion of a precast concrete pipe coupling formed in the mold of FIGS. 9 and 10.

FIG. 14 is a top perspective view of the bottom portion of the precast concrete pipe coupling of FIG. 13.

FIG. 15 is a top perspective view of an assembled precast concrete pipe coupling with precast concrete pipe coupling portions formed in the mold of FIGS. 9 and 10.

FIG. 16 is a top view of a bottom portion of another precast concrete pipe coupling formed in the mold similar to that of FIGS. 9 and 10 and with an alternative core configuration.

FIG. 17 is a top perspective view of the bottom portion of the precast concrete pipe coupling of FIG. 16.

FIG. 18 is a top perspective view of another assembled precast concrete pipe coupling with precast concrete pipe coupling portions formed in the mold of FIGS. 9 and 10.

FIG. 19 is a first end view of a precast concrete monolithic pipe coupling mold according to certain aspects of an embodiment of the invention.

FIG. 20 is a second end view of the precast concrete monolithic pipe coupling mold of FIG. 19.

FIG. 21 is a side view of the precast concrete monolithic pipe coupling mold of FIG. 19.

FIG. 22 is a first top side view of the molding chamber of the precast concrete monolithic pipe coupling of FIG. 19.

FIG. 23 is a second top side view of the molding chamber of FIG. 22.

FIG. 24 is a first side view of the precast concrete monolithic pipe coupling mold of FIG. 19 with the molding chamber in an open position.

FIG. 25 is a second side view of the precast concrete monolithic pipe coupling mold of FIG. 19 with the molding chamber in an open position.

FIGS. 26(a)-26(c) are side perspective, top, and side perspective cross-sectional views, respectively, of a precast concrete monolithic pipe coupling according to further aspects of an embodiment of the invention.

FIGS. 27(a)-27(c) are side perspective, top, and side perspective cross-sectional views, respectively, of another precast concrete monolithic pipe coupling according to further aspects of an embodiment of the invention.

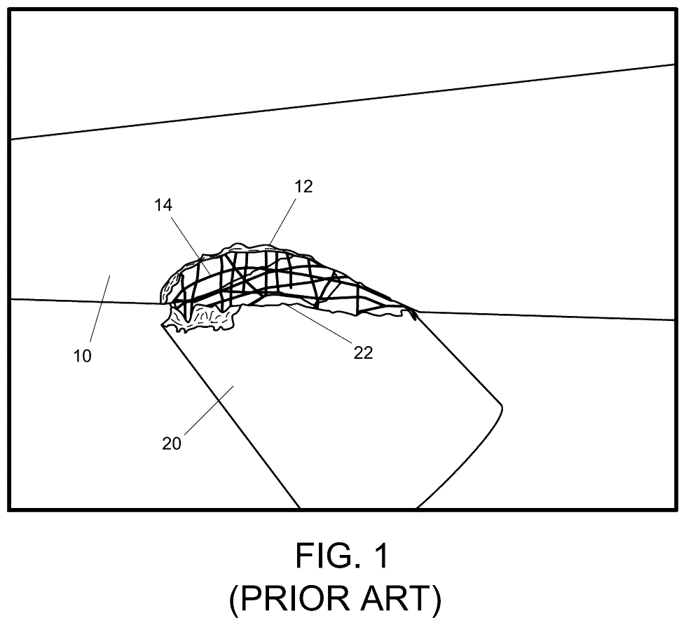

### DETAILED DESCRIPTION OF THE PREFERRED EMBODIMENTS

The invention may be understood by referring to the following description and accompanying drawings. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

Descriptions of well-known functions and structures are omitted to enhance clarity and conciseness. The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item.

The use of the terms “first”, “second”, and the like does not imply any particular order, but they are included to identify individual elements. Moreover, the use of the terms first, second, etc. does not denote any order of importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although some features may be described with respect to individual exemplary embodiments, aspects need not be limited thereto such that features from one or more exemplary embodiments may be combinable with other features from one or more exemplary embodiments.

In accordance with certain aspects of an embodiment of the invention, a mold is configured to form two mating, monolithic, unitarily-formed and one-piece blocks of a pipe coupling configured for mating connection to one another to form a single block pipe coupling having a non-linear flow channel, such as a multi-direction channel such as a Y-shaped connection or a bend, formed inside of the pipe coupling, without requiring scoring, cutting, and rejoining of linear pipe sections. As used herein, the terms “monolithic,” “unitarily-formed,” and “one-piece” all refer to a unit that is formed as an individual solid configuration at its formation, without gluing, cementing, welding, bolting, or otherwise joining separate portions of that unit together to form the unit, and thus that does not comprise joints, joined seams, or other mating faces, mating edges, or mating points or lines of contact in the single unit. Likewise, the term “monolithic concrete pipe coupling” as used herein refers to a monolithic, unitarily-formed, and/or one-piece concrete pipe coupling having a non-linear flow channel extending through the coupling, such as by way of non-limiting example a Y-joint or a curved flow channel, that is provided at its open ends with a configuration enabling attachment of such open ends with an end of a linear concrete pipe. Further, the term “molded” as used herein refers to a method of manufacturing a monolithic, unitarily-formed, and/or one-piece pipe coupling in accordance with the invention by forming a cast concrete monolithic coupling in a mold or molding machine from a monolithic concrete pour. Still further, the term “non-linear flow channel” refers to a flow channel formed in a concrete coupling in accordance with aspects of the invention that branches its flow from a first part of the channel to another part of the channel that has a longitudinal axis different from the first part of the channel, or that bends or curves its flow from a first part of the channel to another part of the channel. Similarly, a generally cylindrical non-linear flow channel refers to such a non-linear flow channel in which all portions of the flow channel comprise a generally round flow channel cross-section, such as circular, oblong, or the like, surrounded in its entirety by concrete of the concrete coupling.

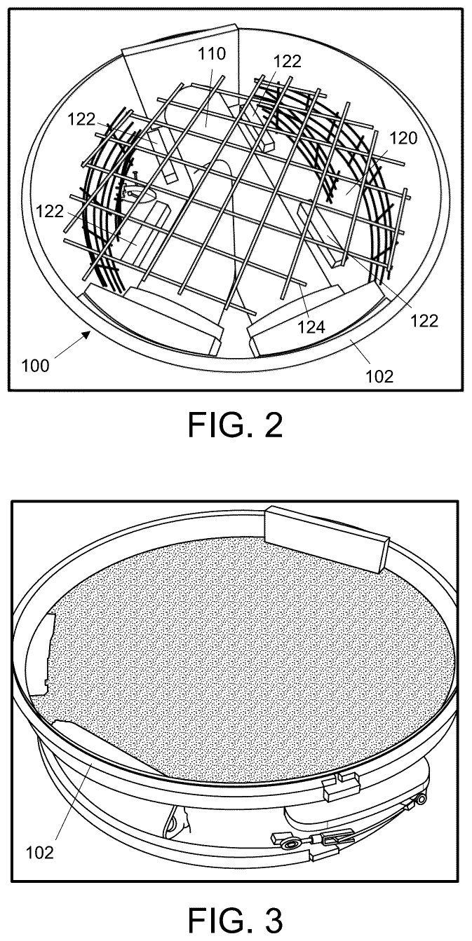

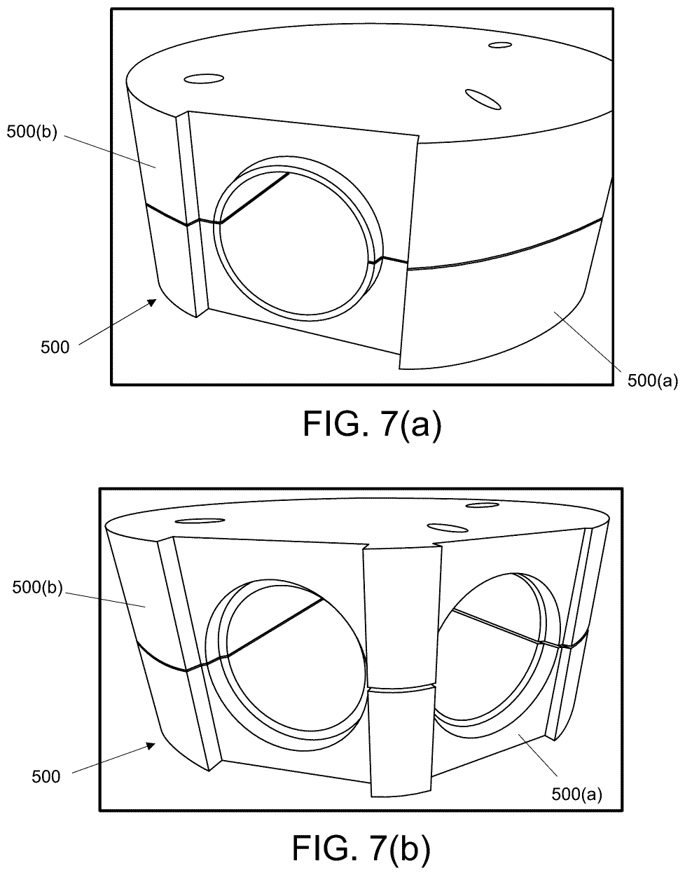

In accordance with certain aspects of a first embodiment of the invention, FIG. 2 shows an exemplary mold 100 for forming a concrete pipe coupling 500 (FIGS. 7(a) and 7(b)) incorporating, by way of non-limiting example, a Y-type intersection. With particular reference to FIGS. 7(a) and 7(b), and particularly with regard to specific aspects of a first embodiment of the invention, the resulting coupling 500 is formed by monolithic lower and upper halves 500(a) and 500(b), respectively, each having a flat outer surface that forms one of the top or bottom of the completed coupling 500 to ensure a highly stable base when the coupling 500 is placed at the intended location for joining two or more linear pipe sections. The resulting coupling 500 thus provides an intersecting or bending pipe connection without a pipe or pipes themselves forming that intersecting or bending connection.

With continuing reference to FIG. 2, exemplary mold 100 includes an outer wall 102, a male conduit form 110 forming a mold core with primary and secondary core branches, and a generally flat, planar bottom wall 120 that will form a flat mating wall 121 with another half of coupling 500. During the molding process (in which wet concrete having a slump of between 5-30 inches, more preferably between 10-25 inches, and most preferably of 20-25 inches, and in one preferred embodiment of 25 inches, is poured into mold 100), male conduit form 110 will form a circular channel or conduit of like configuration to the interior of a concrete pipe that is to be joined to molded coupling 500, with the exception that such channel will include a curve or intersecting section as defined by male conduit form 110. In certain configurations (and as discussed in greater detail below), male conduit form 110 may be formed of the same material as the rest of mold 100, such as rigid steel. In other exemplary configurations and as shown particularly in FIG. 2, male conduit form 110 may be formed of Styrofoam or similarly configured material that, after molding of a monolithic half of coupling 500, may then be removed (such as by scraping, cleaning, and the like) from the completed monolithic molded half of coupling 500. While the exemplary molded half of coupling 500 shown in FIG. 2 shows a single intersection of one pipe section with another pipe section, those skilled in the art will recognize that molded coupling 500 may be provided in a variety of configurations, including additional or no intersections, and one or more curves, without departing from the spirit and scope of the invention.

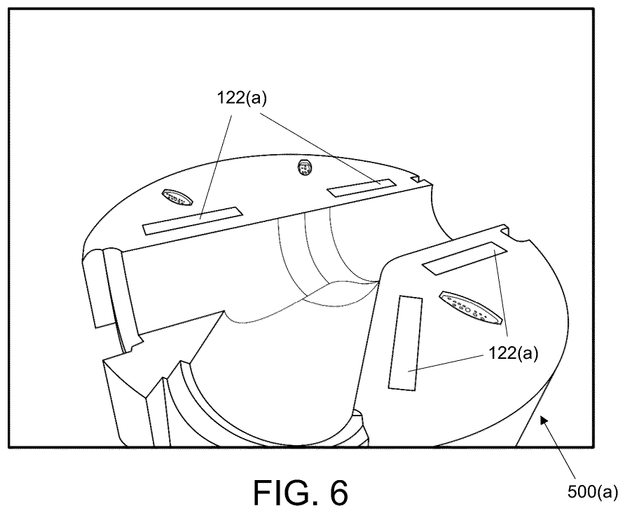

Mold 100 preferably includes alignment tab portions 122 that may be used for alignment of two, separate molded halves 500(a) and 500(b) of coupling 500. More particularly, when forming two halves of a single coupling 500, the mold for a first half may be provided blocks that are inserted into alignment tab portions 122, which when present during molding will form recesses 122(a) in the top, flat wall of the molded half of coupling 500, as seen in FIG. 6 (showing the blocks to be removed from molded recesses 122(a)). Likewise, when blocks are removed from alignment tab portions 122 of mold 100 and a half of coupling 500 is molded, alignment tabs 122(b) configured to mate with recesses 122(a) are formed in the top, flat wall of the molded half of coupling 500, as shown in FIG. 5. Thus, when completed halves 500(a) and 500(b) of coupling 500 are brought together (as discussed in further detail below), alignment tabs 122(b) will extend into alignment recesses 122(a) to ensure proper alignment of the two halves to form a finished coupling 500, as shown in FIGS. 7(a) and 7(b).

As the two halves of a single coupling 500 are essentially mirror images of one another (with the exception of alignment recesses 122(a) and alignment tabs 122(b)), those skilled in the art will recognize that a single mold assembly 100 as shown in FIG. 2 may be used to form both monolithic halves 500(a) and 500(b) of coupling 500, with the entire mold 100 simply turned upside-down within outer wall 102 to form the second one of a pair of halves of a coupling 500.

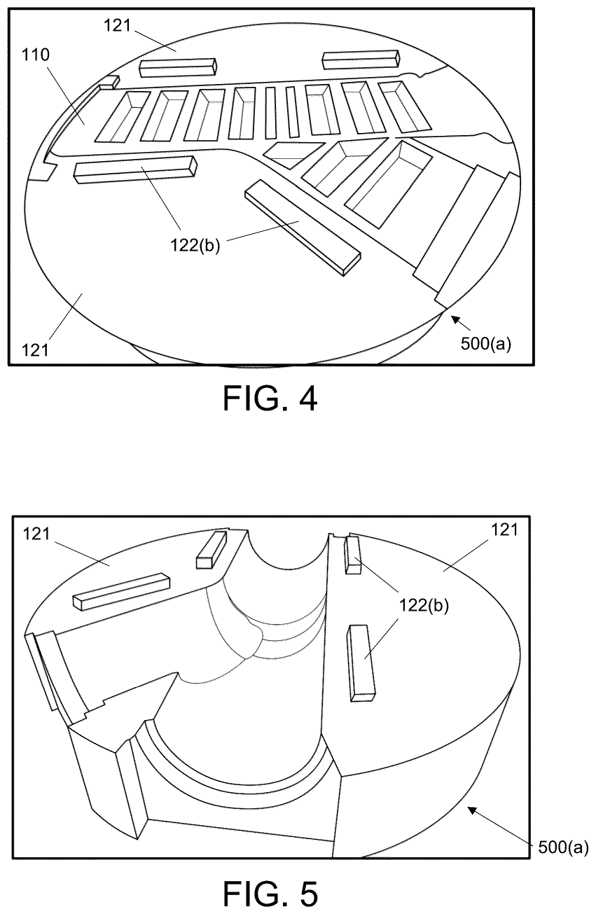

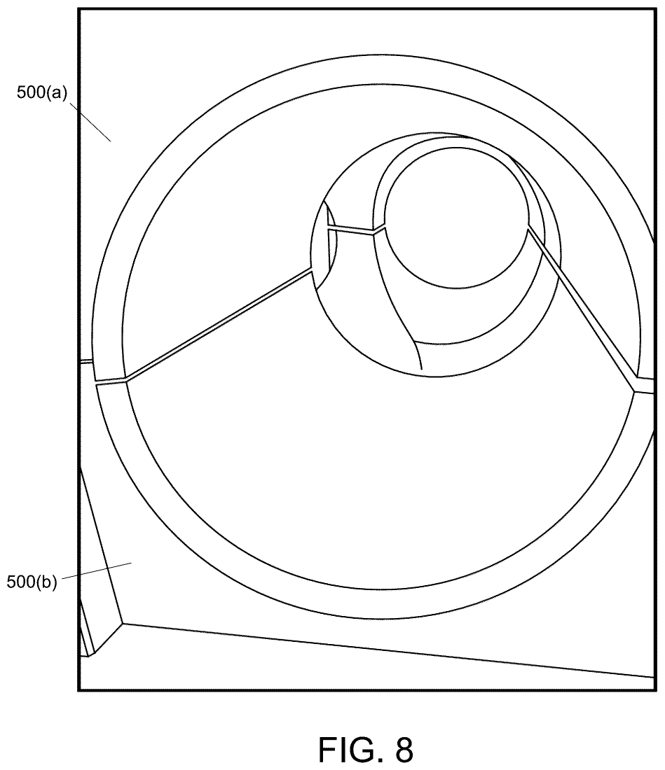

Wire mesh reinforcement 124 is also preferably molded into each monolithic half of coupling 500 to add structural support, and is positioned between male conduit form 110 and a top of mold 100. As shown in FIG. 3, mesh reinforcement 124 is encased within the concrete inside of mold 100 between male conduit form 110 and the top surface of the concrete. Once cured, and as shown in FIG. 4, the completed monolithic half of coupling 500 is removed from mold 100 and prepared for assembly with a paired monolithic half of coupling 500 to form a complete coupling. In those exemplary configurations in which male conduit form 110 is formed of Styrofoam (as seen in FIG. 4), such Styrofoam may then be removed from the cured half of coupling 500, such as by cleaning, scraping, and the like, to form a completed monolithic half of coupling 500 (as shown in FIG. 5). FIG. 8 shows a close-up view of a completed coupling 500 with monolithic halves 500(a) and 500(b) having been joined to one another and forming a fluid conduit extending through the coupling 500, including an intersection between multiple pipe sections. Preferably, each end of the fluid conduits extending through coupling 500 are provided a configuration matching that of linear sections of concrete pipe of traditional configuration to which coupling 500 is to be joined.

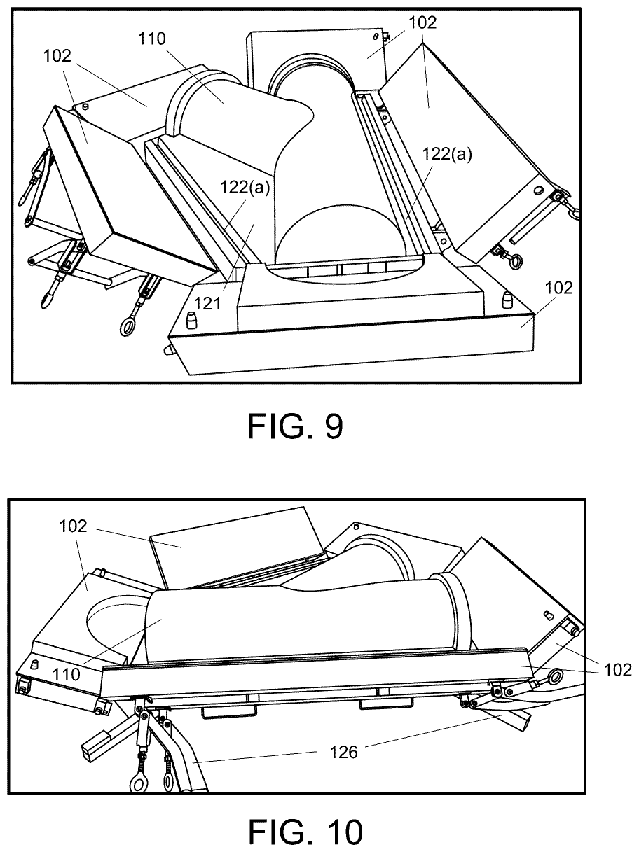

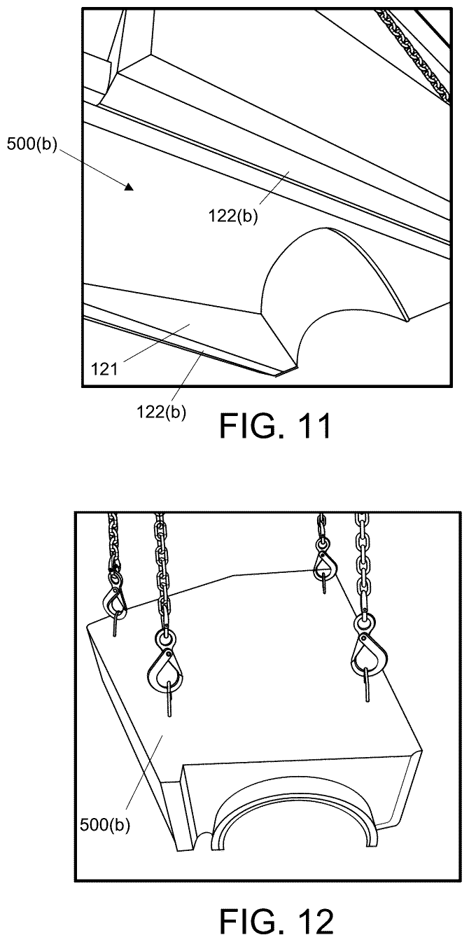

FIGS. 9 and 10 show a configuration of mold 100 in which the primary and secondary cores of male conduit form 110 are formed of steel, which may aid in separation of a molded monolithic half of coupling 500 from mold 100 without scraping or cleaning of Styrofoam. In this configuration and in accordance with further aspects of an embodiment of the invention, male conduit form 110 again forms the shape of the conduit that is to extend through coupling 500, whether that comprise one or more intersections or curves. Likewise, outer wall 102 need not be circular, but instead may comprise any shape as may be desired to fit particular applications. To aid in opening and closing of mold 100, outer wall 102 may be formed of multiple hinged wall sections that may be brought vertically upright during a molding operation to form a closed mold perimeter around male conduit form 110, with a bottom edge of each such hinged wall section extending at least to bottom wall 120 of mold 100 to form a sealed mold. Alignment recesses 122(a) are shown extending into bottom wall 120 of mold 100 in FIG. 9, and those skilled in the art will recognize that a mirror version of the mold of FIG. 9 may likewise be provided for the second half of coupling 500, and may include alignment tabs 122(b) configured for mating engagement with alignment recesses 122(a). When closed, adjustable clamp arms 126 may be provided to clamp each section of outer wall 102 in its closed position as the molding process is carried out. FIG. 11 shows a bottom view of an exemplary monolithic upper half 500(b) of a coupling 500 formed with alignment tabs 122(b), and FIG. 12 shows a top view of that same upper half 500(b) of a coupling 500 being moved to a location at which it may be joined to a monolithic lower half 500(a) of that coupling 500. Preferably, lift eyes or similar mechanism are molded into the flat, top face of monolithic upper half 500(b) of each coupling 500 to enable lifting and manipulation for placement on a monolithic lower half 500(a) of coupling 500.

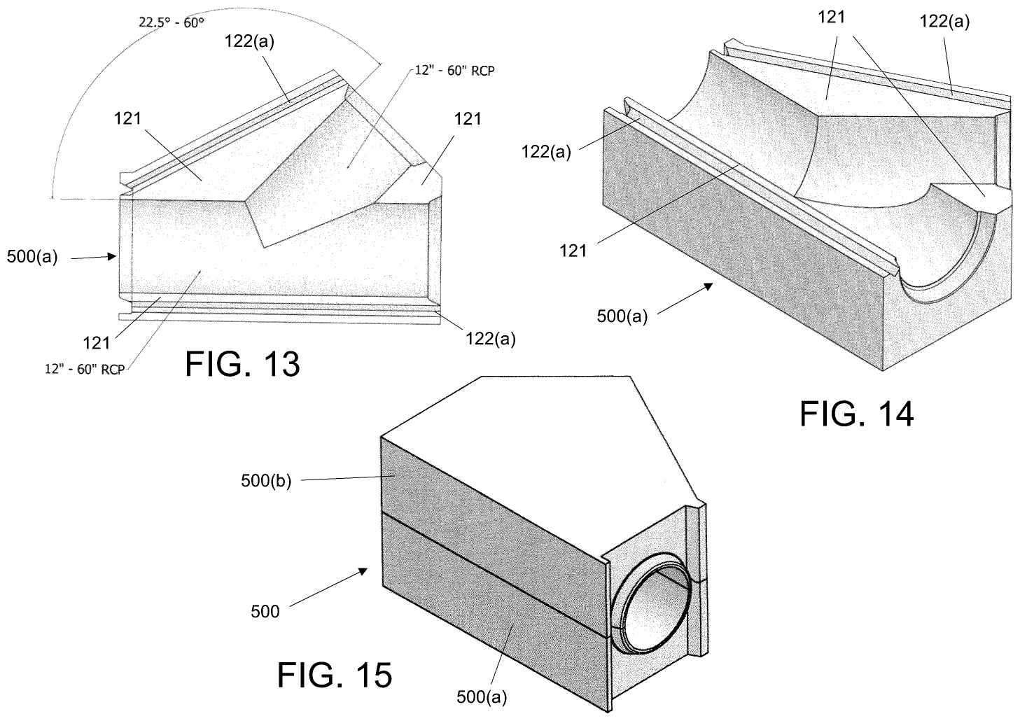

FIGS. 13 and 14 show top and perspective views, respectively, of a finished monolithic lower half 500(a) of a concrete coupling 500 configured with a single pipe intersection (all dimensions being exemplary only). As explained above, a finished monolithic upper half 500(b) having a mirror configuration to that of monolithic lower half 500(a) may be formed by the same process, with the exception that one of halves 500(a) and 500(b) is provided alignment recesses 122(a), and the other of halves 500(a) and 500(b) is provided alignment tabs 122(b). The ends of the conduit formed in each of lower half 500(a) and upper half 500(b) are provided a configuration enabling mating with standard linear sections of concrete pipe. Each of lower half 500(a) and upper half 500(b) of coupling 500 have sections of flat mating wall 121 (formed in each case by bottom wall 120 of mold 100) on opposite sides of each conduit portion to provide a mating surface between monolithic lower half 500(a) and monolithic upper half 500(b) of a single coupling 500. Preferably, mastic, mortar, adhesive, or other similarly configured joining materials may be provided to join the two halves 500(a) and 500(b) together in a fluid-tight connection. FIG. 15 shows a fully assembled exemplary coupling 500 formed from the mold assembly shown in FIGS. 9 and 10 and having a generally cylindrical, non-linear (i.e., Y-branching) flow channel 502 extending through the coupling 500.

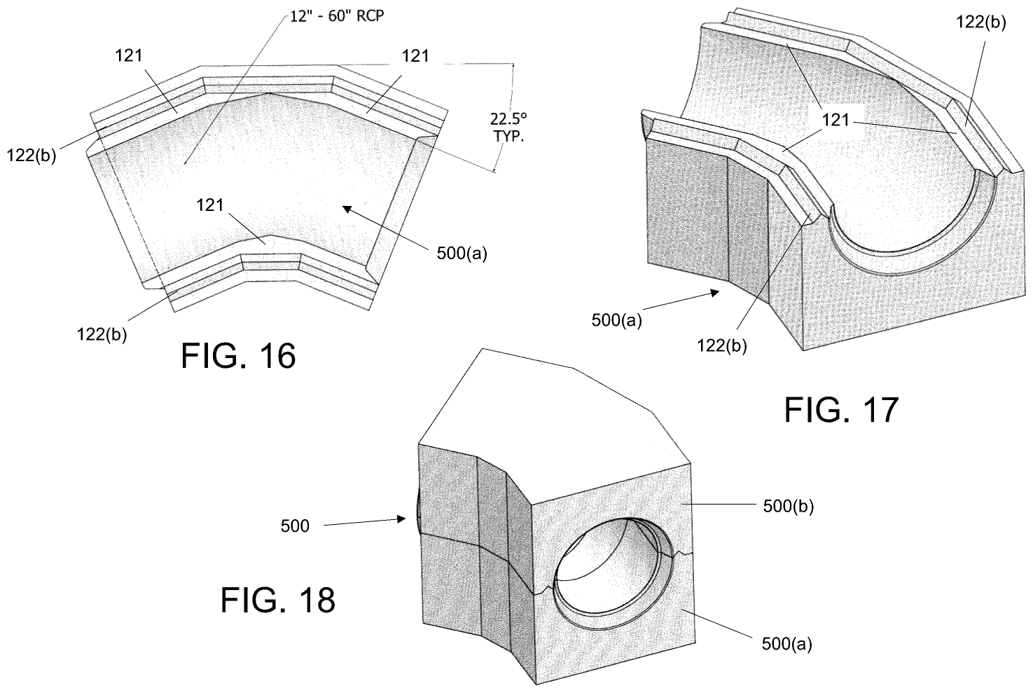

Similarly, FIGS. 16 and 17 show top and perspective views, respectively, of a finished monolithic lower half 500(a) of a coupling configured with a curve (all dimensions being exemplary only). Once again, a finished monolithic upper half 500(b) having a mirror configuration may be formed by the same process, with the exception that one of halves 500(a) and 500(b) is provided alignment recesses 122(a), and the other of halves 500(a) and 500(b) is provided alignment tabs 122(b). The ends of the conduit formed in each of lower half 500(a) and 500(b) are again provided a configuration enabling mating with standard linear sections of concrete pipe. Each of lower half 500(a) and upper half 500(b) of curved coupling 500 likewise again have sections of flat mating wall 121 (formed in each case by bottom wall 120 of mold 100) on opposite sides of each conduit portion to provide a mating surface between lower half 500(a) and upper half 500(b) of a single coupling 500. Once again, preferably mastic, mortar, adhesive, or other similarly configured joining materials may be provided to join the two monolithic halves 500(a) and 500(b) together in a fluid-tight connection to form curved coupling 500. FIG. 18 shows a fully assembled exemplary curved coupling 500 again formed generally from the systems and methods discussed above, and having a generally cylindrical, non-linear (i.e., curved) flow channel 502 extending through the coupling 500.

Importantly, in each case, coupling 500 has a flat top face 504 and a flat bottom face 506. This configuration not only allows for easy placement at an installation site (as such installation simply requires a leveled ground surface on which to place coupling 500, as opposed to manually rotating a heavy concrete fitting to achieve the intended angular orientation required by previously known pipe fittings), but likewise vastly improves upon storage capacity in a storage yard of a manufacturing facility. More particularly, multiple couplings 500 may be stacked one atop the other, multiple units high, due to the flat top and bottom faces, 504 and 506, respectively.

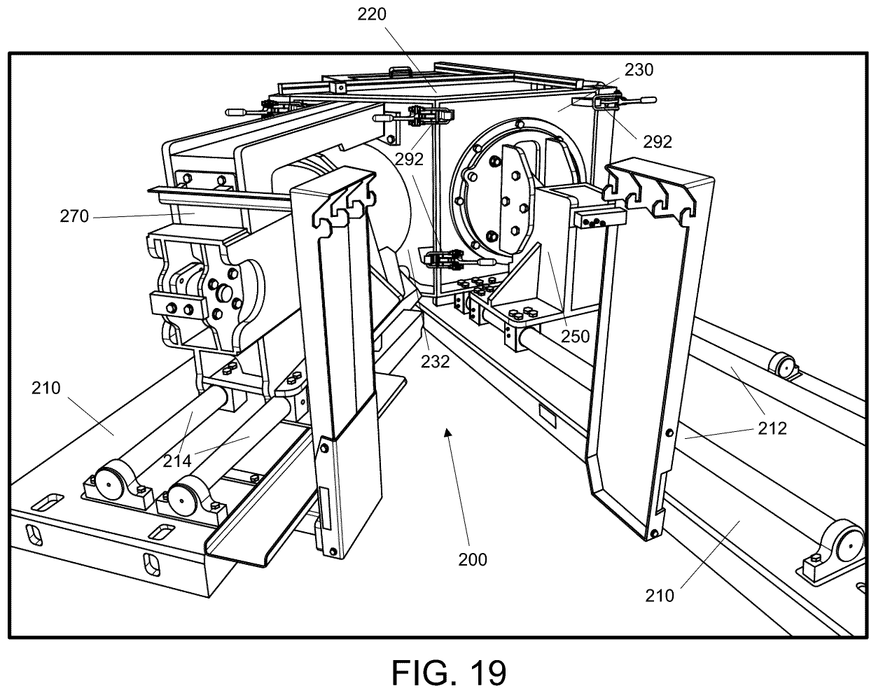

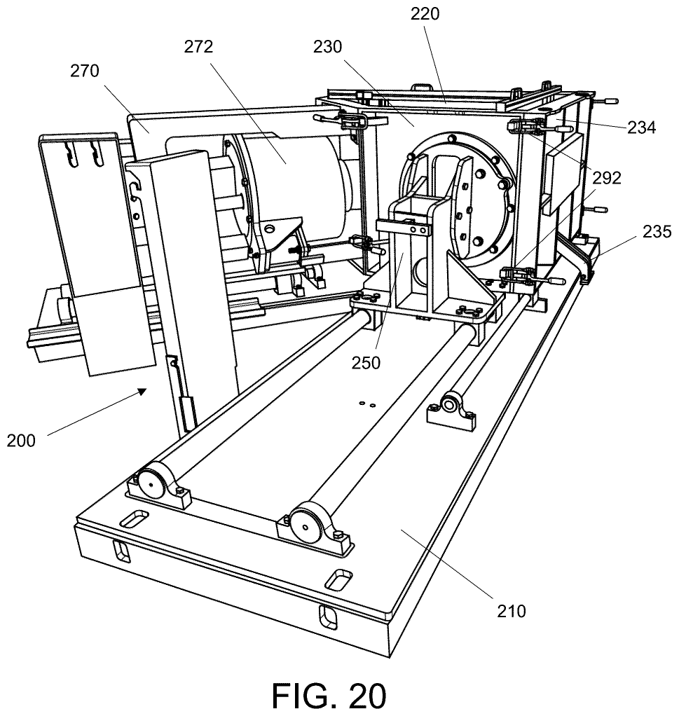

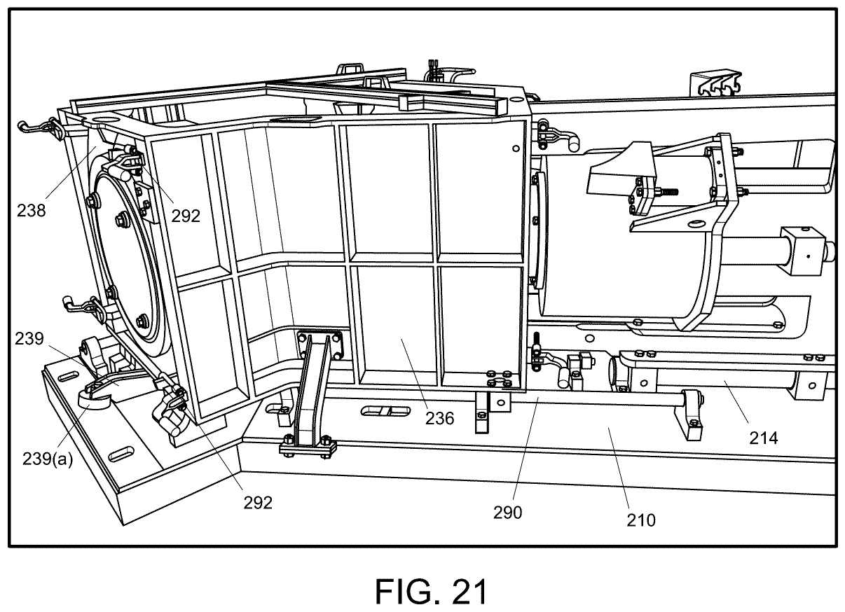

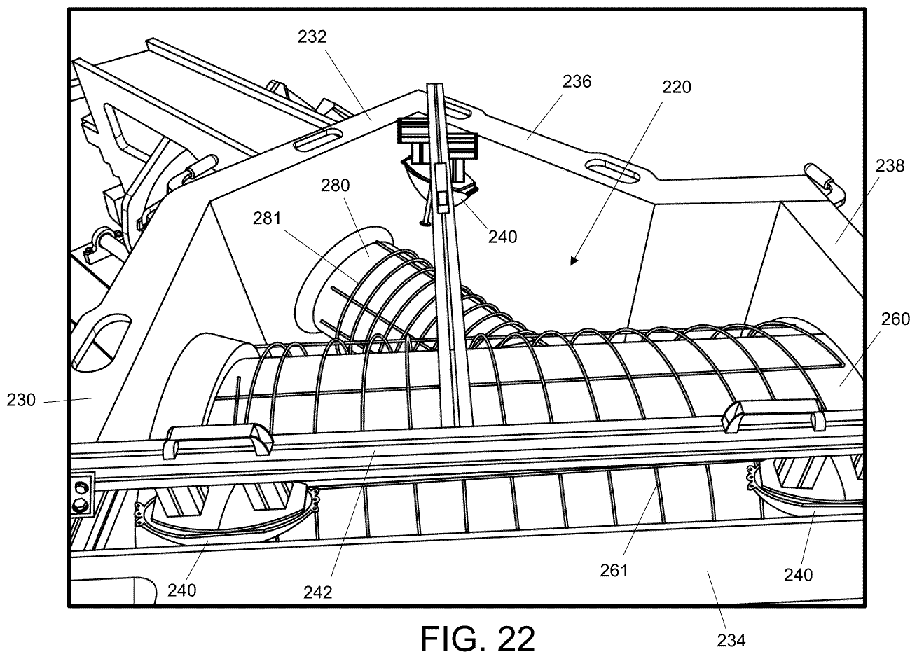

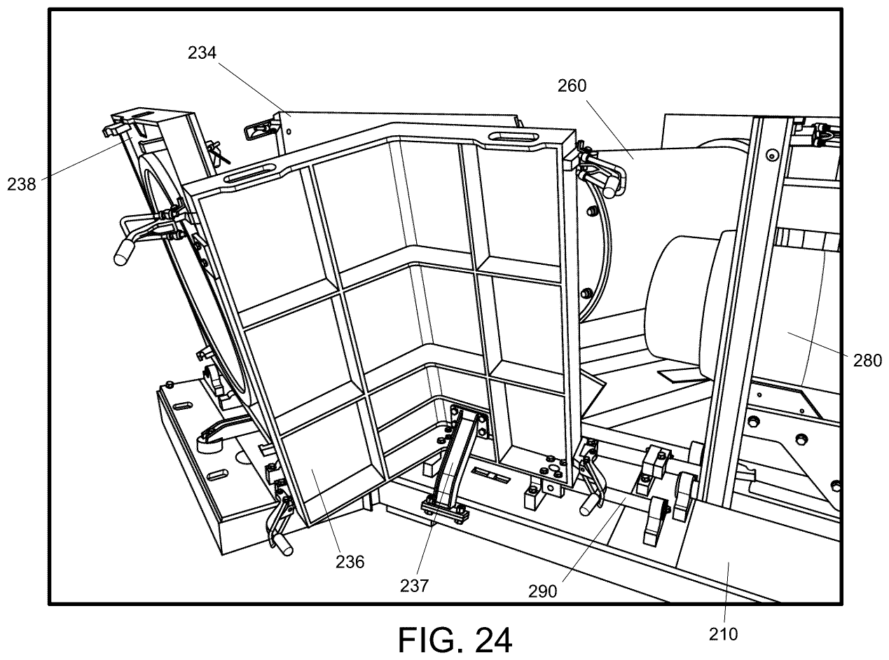

Next and with respect to a second embodiment of the invention, a precast concrete monolithic pipe coupling mold 200 is provided as shown in FIGS. 19-25. Mold 200 is particularly configured to form a single monolithic pipe coupling, as opposed to monolithic pipe coupling halves as discussed above. With particular reference to FIGS. 19-22, mold 200 includes a base 210, a monolithic molding chamber 220 defined by moveable walls 230, 232, 234, 236, and 238 (as discussed further below), a primary core sled 250 carrying a primary mold core 260 (FIGS. 22-25), and a secondary core sled 270 carrying a secondary mold core 280 (FIGS. 22-25). Primary mold core 260 and secondary mold core 280 may have differing or the same diameters and curves in order to meet the particular coupling requirements of a given production sequence. Primary core sled 250 is slidably mounted to primary core sled rails 212 affixed to base 210, and is preferably hydraulically driven to move primary core 260 into and out of monolithic molding chamber 220. Primary core sled mold wall 230 is affixed to primary core sled 250, such that primary core 260 extends inward into monolithic molding chamber 220 from the interior side of primary core mold wall 230, and such that primary core sled mold wall 230 moves along base 210 above slide rails 212 as primary core sled 250 moves towards and away from monolithic molding chamber 220.

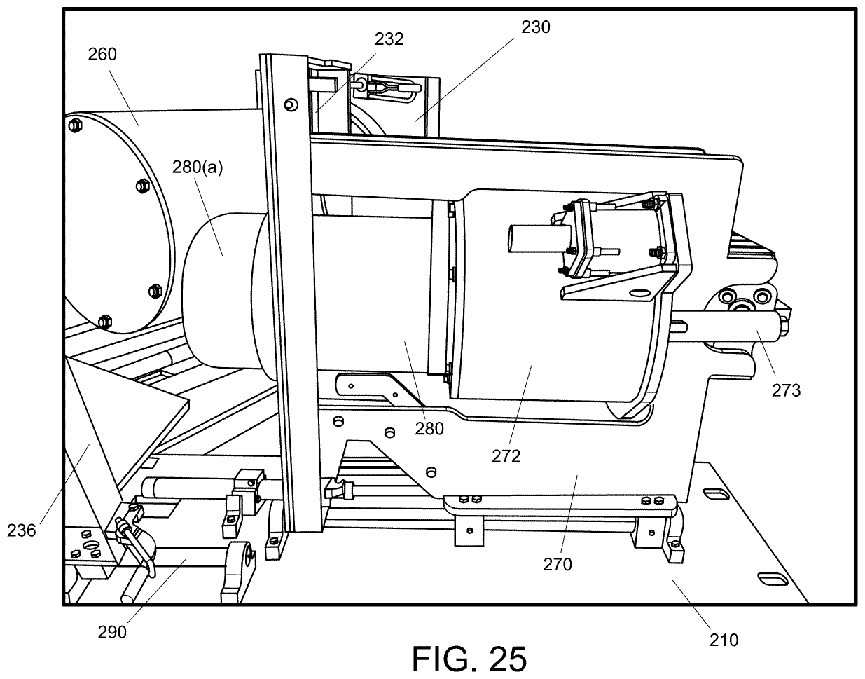

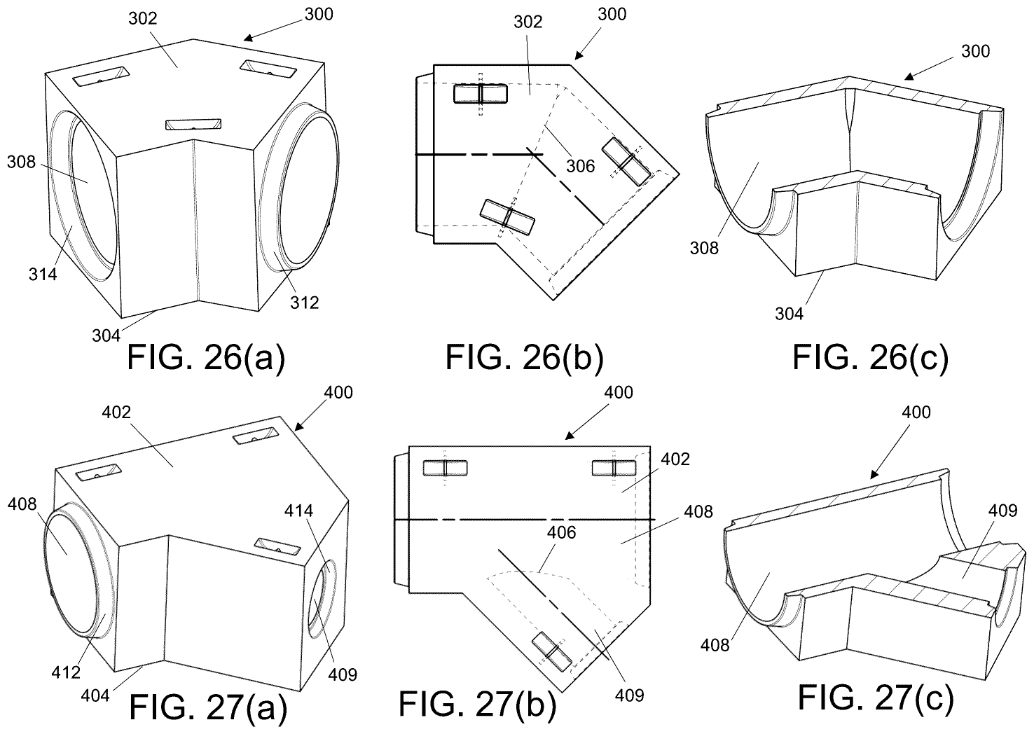

Likewise, secondary core sled 270 is slidably mounted to secondary core sled rails 214 affixed to base 210, and is preferably hydraulically driven to move secondary core 280 into and out of monolithic molding chamber 220. Secondary core sled mold wall 232 is affixed to secondary core sled 270, such that secondary core 280 extends inward into monolithic molding chamber 220 from the interior side of secondary core mold wall 232, and such that secondary core sled mold wall 232 moves along base 210 above secondary slide rails 214 as secondary core sled 270 moves towards and away from monolithic molding chamber 220. Further, and as best shown in FIG. 25, secondary core sled 270 may carry a cylinder 272 that houses secondary core 280 in a manner such that secondary core 280 is extensible from cylinder 272, through secondary core sled mold wall 232 into monolithic molding chamber 220. A piston 273 is preferably hydraulically driven through cylinder 272 and affixed to secondary core 280, such that once secondary core sled mold wall 232 has been moved along slide rails 214 to mate with primary core sled mold wall 230 and mold wall 236, the piston 273 may hydraulically drive secondary core 280 into monolithic molding chamber 220 for it to come into contact with the exterior of primary core 260. The front, distal face 280(a) of secondary core 280 is formed having a face that matches and thus mates closely with primary core 260 at the intended point of connection to ensure a smooth transition in the formed monolithic pipe coupling between flow sections formed by primary core 260 and secondary core 280. In certain configurations, and particularly those in which monolithic molding chamber is to be used to form a Y-joint concrete coupling, the front, distal face 280(a) of secondary core 280 comprises a curved face having a contour that matches the cylindrical exterior of primary core 260. In other configurations, and particularly those in which monolithic molding chamber is to be used to form a curved or bending concrete coupling, the front, distal face 280(a) of secondary core 280 comprises a perimeter edge of an interior perimeter edge of primary core 260.

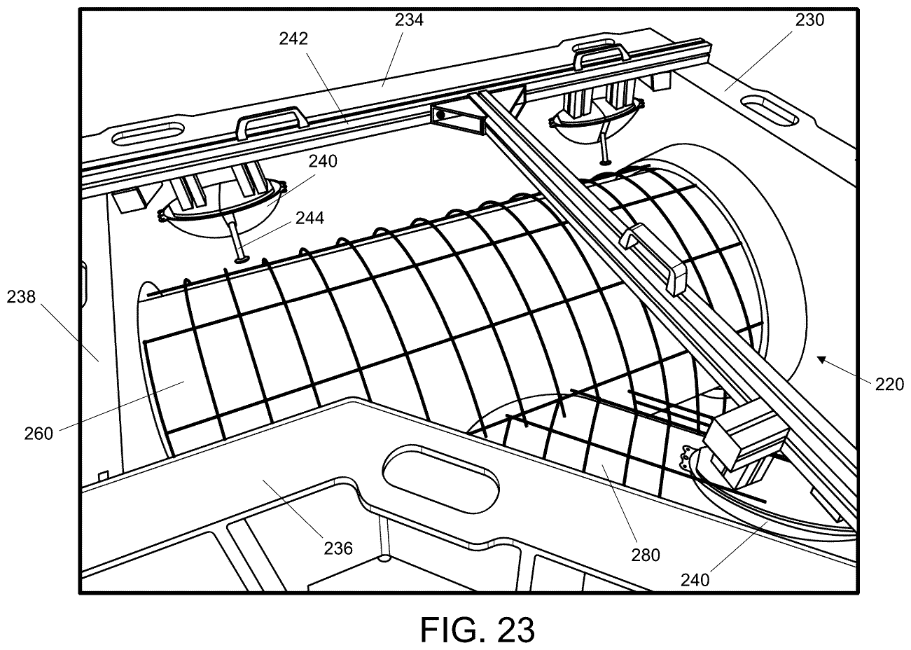

As best viewed in FIGS. 22 and 23, when all of the mold walls 230, 232, 234, 236, and 238 are closed and primary core 260 and secondary core 280 are fully inserted into monolithic molding chamber 220, molding chamber 220 may receive a monolithic concrete pour that flows concrete down to the floor of molding chamber 220, around both the primary core 260 and the secondary core 280, and up to a top of, or below but adjacent to the top of, the molding chamber 220. Preferably, before such concrete pour, steel reinforcement caging 261 is positioned around primary core 260, and steel reinforcement caging 281 is positioned around secondary core 280, to add structural support to the formed monolithic pipe coupling around each of the formed flow channels. Hook anchor mounts 240 may be releasably suspended from an anchor mount support bar 242 positioned over the open top of molding chamber 220 with hook anchor mounts 240 positioned to sit within the top face of the formed monolithic pipe coupling. Each such hook anchor mount 240 includes a generally V-shaped steel anchor 244 that is cast into the monolithic concrete pipe coupling, with the vertex of the anchor 244 extending outward from the top of the monolithic pipe coupling, allowing crane hooks to lift the formed monolithic concrete pipe coupling from the mold 200 when the coupling has cured.

In contrast to pipe members formed by centrifugal molding that must hold their shape immediately after casting, a monolithic concrete pipe coupling formed in precast concrete monolithic pipe coupling mold 200 can take additional time to cure. As a result, concrete having a slump of between 5-30 inches, more preferably between 10-25 inches, and most preferably of 20-25 inches, and in a particularly preferred embodiment of 25 inches, may again be poured for forming the monolithic concrete pipe coupling. The greater flowability of such concrete (in comparison with previous dry concrete pipe manufacturing processes) within monolithic molding chamber 220 provides for a significantly smoother finish than has been available in dry concrete casting processes, providing both a smoother exterior and a smoother interior along the walls of the formed flow channels in the monolithic pipe coupling, thus avoiding burs and imperfections that might cause debris to snag when the coupling is placed into use in a municipal flow system.

Following the molding and curing of a monolithic concrete coupling in molding chamber 200, the mold is opened to allow removal of the coupling. To open the mold, secondary core 280 is hydraulically retracted at least partially into the cylinder 272 of secondary core sled 270, and secondary core sled 270 is hydraulically moved away from the molding chamber 220. Likewise, primary core sled 250 is hydraulically moved away from molding chamber 200, thus withdrawing primary core 260 from the formed monolithic concrete coupling. Further, each of mold walls 234, 236, and 238 are moved away from the formed monolithic concrete coupling by angling each such wall outward with respect to a vertical wall of the formed monolithic concrete coupling. More particularly, mold walls 234, 236, and 238 are each pivotably mounted to a separate mold wall pivot bar 290, enabling each of such mold walls 234, 236 and 238 to be pivoted outward about its respective mold wall pivot bar 290 and away from the formed monolithic concrete coupling. In order to restrict the extent to which mold wall 234 may be pivoted outward, a pivot stop arm 235 extends downward from the exterior of mold wall 234 and is positioned to contact an outer sidewall of base 210 to stop angular rotation of mold wall 234. Likewise, in order to restrict the extent to which mold wall 236 may be pivoted outward, a pivot stop arm 237 extends downward from the exterior of mold wall 236 and is positioned to contact an outer sidewall of base 210 to stop angular rotation of mold wall 236. Optionally, each pivot stop arm may be provided a compressible bumper to cushion the contact between the respective pivot stop arm and base 210. Further and similarly, in order to restrict the extent to which mold wall 238 may be pivoted outward, a pivot stop arm 239 extends downward from the exterior of mold wall 238 and likewise may have a bumper 239(a) positioned to contact base 210 to stop angular rotation of mold wall 239. After the mold has been opened, an overhead crane may lift the formed monolithic concrete coupling out of molding chamber 220 by connecting chain hooks to anchors 244.

Preferably, each adjacent pair of sidewalls 230, 232, 234, 236, and 238 are further equipped with upper and lower U-hook latch clamps 292 that tightly pull the adjacent vertical edges of each pair of mold walls towards one another to form a sealed mold.

Next and with particular reference to FIGS. 27(a)-27(c), an exemplary precast concrete monolithic pipe coupling 300 is shown that is formed from the monolithic pipe coupling mold 200 and using the related molding process as discussed above. In this exemplary configuration, monolithic pipe coupling 300 is a bending pipe coupling for joining two pipe sections at their ends at angles to one another. Monolithic pipe coupling 300 has a flat top 302 and a flat base 304, enabling easy installation and, significantly, stable stacking in a storage location, such as a storage yard of a manufacturing facility. The monolithic bending pipe coupling 300 may be formed when mold 200 is provided a first core and a second core having, as discussed above, mating interior faces configured to form a connection along intersection line 306, thus forming a continuous flow channel 308 without significant burs, rough edges, or similar obstructions in the flow channel, particularly when formed with mold 200 and using a wet concrete formulation as discussed above. An outer male pipe coupling rim 312 is provided at a first end of monolithic pipe coupling 300 for attachment to a female connecting rim of a standard linear concrete pipe, and an inner female pipe coupling rim 314 is provided at the second end of monolithic pipe coupling 300 for attachment to a male connecting rim of a standard linear concrete pipe.

Likewise and with particular reference to FIGS. 28(a)-28(c), an exemplary precast concrete monolithic pipe coupling 400 is shown that similarly is formed from the monolithic pipe coupling mold 200 and using the related molding process as discussed above. In this exemplary configuration, monolithic pipe coupling 400 is a Y-intersection pipe coupling for intersecting one pipe with another pipe, with the two pipe sections again at angles to one another. Monolithic pipe coupling 400 has a flat top 402 and a flat base 404, again enabling easy installation and, significantly, stable stacking in a storage location, such as a storage yard of a manufacturing facility. The monolithic Y-intersection pipe coupling 400 may be formed when mold 200 is provided a primary core and a secondary core particularly as shown in the exemplary Figures of mold 200 above and having, once again, a primary core and a secondary core having a curved forward face for mating against the exterior of the primary core, thus forming a connection along intersection line 406 resulting in a smooth transition from secondary flow channel 409 into primary flow channel 408 without significant burs, rough edges, or similar obstructions in the flow channel, particularly when formed with mold 200 and using a wet concrete formulation as discussed above. An outer male pipe coupling rim 412 is provided at a first end of monolithic pipe coupling 400 for attachment to a female connecting rim of a standard linear concrete pipe, and inner female pipe coupling rims 414 are provided at the opposite end of the primary flow channel 408 through monolithic pipe coupling 400 and at the start of the secondary flow channel 409 through monolithic pipe coupling 400, each configured for attachment to a male connecting rim of a standard linear concrete pipe.

The foregoing systems and methods may thus be used to form a concrete pipe coupling providing one or more fluid conduit intersections and/or one or more fluid conduit curves without using concrete pipe members to form those connections. Standard concrete pipes may be joined in standard fashion to the inlets and outlets of couplings formed in accordance with aspects of the invention to provide intersecting and turning flows without requiring the traditionally excessive labor and waste associated with scoring, cutting, and rejoining of linear pipe sections, thus significantly improving upon the ease of manufacture and installation of such fluid conduit configurations over previously known systems and methods.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. Thus, it should be understood, therefore, that the invention may be practiced otherwise than as specifically set forth herein.

What is claimed is:

1. An apparatus for forming a precast concrete pipe coupling, comprising:
a base;
a plurality of adjustable mold walls attached to the base, each mold being independently moveable and configured to form a sealed perimeter around a molding chamber;
a primary mold core, wherein the primary mold core is configured to form a first part of a non-linear flow channel within the concrete pipe coupling; and
a secondary mold core, wherein the secondary mold core is configured to form a second part of the non-linear flow channel, the secondary mold core being alignable with the primary mold core to complete the non-linear flow channel geometry;
wherein the primary mold core and the secondary mold core are configured to create a precast concrete pipe coupling having an internal flow channel comprising at least one of a Y-junction and a bend.

2. The apparatus of claim 1, wherein the primary mold core is mounted to a primary core sled, and wherein the secondary mold core is mounted to a secondary core sled.

3. The apparatus of claim 2, wherein the primary core sled is moveably mounted to primary core sled rails fixed to the base, and wherein the secondary core sled is moveably mounted to secondary core sled rails fixed to the base and in a direction that is at an angle to the primary core sled rails.

4. The apparatus of claim 3, wherein the secondary core sled further comprises a piston affixed to a back of the secondary mold core and is operable to extend the secondary mold core from the secondary core sled and to retract the secondary mold core to the secondary core sled.

5. The apparatus of claim 1, further comprising at least one mold wall pivot bar mounted to the base, and wherein at least one of the adjustable mold walls is pivotably mounted to the mold wall pivot bar.

6. The apparatus of claim 1, wherein the primary mold core and the secondary mold core are configured with mating surfaces that facilitate precise alignment and joining to one another to form the non-linear flow channels.

7. The apparatus of claim 1, further comprising at least one latch clamp positioned to pull adjacent vertical edges of each adjacent pair of mold walls towards one another to form a sealed mold.

8. A method for manufacturing a precast concrete pipe coupling, comprising the steps of:
arranging a mold apparatus according to claim 1, wherein the adjustable mold walls are positioned to define a specific geometric configuration of the molding chamber corresponding to a desired shape of the concrete pipe coupling;
pouring concrete having a slump of between 5 and 30 inches into the mold apparatus to ensure flowability around the contours of the primary and secondary mold cores;
allowing the concrete to cure within the mold apparatus; and
opening the mold apparatus by removing the primary and secondary mold cores and independently moving the adjustable mold walls to release the formed concrete pipe coupling.

9. The method of claim 8, wherein the concrete has a slump of 10-25 inches.

10. The method of claim 8, wherein the concrete has a slump of 20-25 inches.

11. The method of claim 8, wherein the primary mold core is mounted to a primary core sled, and wherein the secondary mold core is mounted to a secondary core sled.

12. The method of claim 11, wherein the primary core sled is moveably mounted to primary core sled rails fixed to the base, and wherein the secondary core sled is moveably mounted to secondary core sled rails fixed to the base and in a direction that is at an angle to the primary core sled rails, the method further comprising the steps of:
moving the primary core sled along said primary core sled rails toward the molding chamber to insert the primary core into the molding chamber; and
moving the secondary core sled along the secondary core sled rails toward the molding chamber.

13. The apparatus of claim 12, wherein the secondary core sled further comprises a piston affixed to a back of the secondary mold core and is operable to extend the secondary mold core from the secondary core sled and to retract said secondary mold core to the secondary core sled, the method further comprising the steps of:
moving the secondary core into the molding chamber after the secondary core sled has been moved toward the molding chamber.

14. The method of claim 8, the mold apparatus further comprising at least one mold wall pivot bar mounted to the base, and wherein at least one of the adjustable mold walls is pivotably mounted to the mold wall pivot bar, wherein the step of independently moving the adjustable mold walls further comprises pivoting at least one of the adjustable mold walls about the at least one mold wall pivot bar and away from the formed concrete pipe coupling.

15. The method of claim 8, wherein the primary mold core and the secondary mold core are configured with mating surfaces that facilitate precise alignment and joining to one another to form the non-linear flow channels, the method further comprising the step of moving the mating surface of the secondary mold core into contact with the mating surface of the primary mold core inside of the molding chamber to form a continuous non-linear mold core structure.

16. A precast concrete pipe coupling manufactured by the method of claim 8, wherein the precast concrete pipe coupling is characterized by:
a monolithic, unitarily-formed construction;
internal flow channels configured to connect linear concrete pipe sections in intersecting and/or bending connecting joints; and
external surfaces comprising a flat top and a flat bottom configured to facilitate stacking and handling of the precast concrete pipe coupling.

17. The precast concrete pipe coupling of claim 16, wherein the coupling is configured to seamlessly connect with standard linear sections of concrete pipe.

18. The precast concrete pipe coupling of claim 16, wherein the internal flow channels are non-linear and selected from the group consisting of Y-junctions and bends.

19. A precast concrete pipe coupling comprising:
a monolithic body;
a generally cylindrical, non-linear flow channel extending through the monolithic body from a coupling inlet to a coupling outlet, wherein the flow channel is surrounded by concrete of the coupling from the coupling inlet to the coupling outlet;
a flat bottom side; and
a flat top side opposite the flat bottom side.

20. The precast concrete pipe coupling of claim 19, wherein the coupling inlet further comprises an inlet connector configured for mating with an outlet coupling of a concrete pipe of a municipal fluid handling system, and wherein the coupling outlet further comprises an outlet connector configured for mating with an inlet coupling of a concrete pipe of a municipal fluid handling system.

21. The precast concrete pipe coupling of claim 20, wherein said coupling is cast unitarily as a single piece in a concrete mold having walls and a floor configured to form an exterior of the coupling a plurality of moveable mold cores configured to form the generally cylindrical, non-linear flow channel extending through the concrete coupling.
